(19) United States
(12) Patent Application Publication
(10) Pub. No.: US 2018/0357665 A1
(43) Pub. Date: Dec. 13, 2018

(54) System for Calculating Probability of Advertisement Exposure of 360 Game Replay Video

(71) Applicant: MINKONET CORPORATION, Seoul (KR)

(72) Inventors: KYUNG SOO PARK, Gyeonggi-do (KR); Tae Woo KIM, Gyeonggi-do (KR); Dong Hwal Lee, Seoul (KR)

(73) Assignee: MINKONET CORPORATION, Seoul, (KR)

(21) Appl. No.: 16/000,901

(22) Filed: Jun. 6, 2018

(30) Foreign Application Priority Data
Jun. 7, 2017 (KR) 10-2017-0070564

(51) Int. Cl. G06Q 30/02; A63F 13/61; A63F 13/79; A63F 13/52

(52) U.S. Cl. CPC G06Q 30/0246; A63F 13/61; A63F 2300/8082; A63F 13/52; A63F 13/79

(57) ABSTRACT

Provided is a system for calculating an exposure probability of an advertisement of a 360-degree game replay video, and more particularly, to a system for calculating the exposure probability of the advertisement of the 360-degree game replay video, wherein the exposure probability that the advertisement included in the 360-degree game replay video is to be exposed to a user by using a 360-degree display device is pre-calculated when generating the 360-degree game replay video by applying the advertisement to the 360-degree game replay video. The system for calculating the exposure probability of the advertisement of the 360-degree game replay video allows to conduct reasonable calculation of a probability that the advertisement is exposed to the user when the user is watching the 360-degree game replay video to which the advertisement is applied, thereby providing information to be effectively used for placement or sale of advertisements, estimation of advertising costs, etc.

### CROSS-REFERENCE TO RELATED APPLICATION

This application claims the benefit of Korean Patent Application No. 10-2017-0070564, filed on Jun. 7, 2017, in the Korean Intellectual Property Office, the disclosure of which is incorporated herein in its entirety by reference.

### BACKGROUND

### 1. Field

One or more embodiments relate to a system for calculating an exposure probability of an advertisement of a 360-degree game replay video, and more particularly, to a system for calculating the exposure probability of the advertisement of the 360-degree game replay video, wherein the exposure probability of the advertisement included in the 360-degree game replay video, to a user, via a mobile device, a personal computer (PC), a virtual reality (VR) device or the like, is pre-calculated when generating the 360-degree game replay video by applying the advertisement to a game replay video.

### 2. Description of the Related Art

With the increase in the number of game users, more users view game play videos via the Internet or broadcasting.

Game play videos may be replayed and viewed in various manners. A game player may record his or her game play situation and view the recorded video on his or her terminal, or may upload the recorded video to a server such as YouTube for others to view. In addition, a game play situation may be relayed in real time via a cable broadcasting or an internet broadcasting.

Recently, such game replay videos have been frequently provided as a video in a 360-degree format. Moreover, for games that operate in a virtual reality (VR) environment, a game play situation of the games may be recorded and provided as a replay video in a 360-degree format.

Videos in a 360-degree format as described above are created as a video to be displayed on a virtual spherical screen, and a user may manipulate a 360-degree display device in a desired direction wished by the user to view a video displayed in that direction. That is, the user does not view the whole game replay video but only a video in a direction wished by the user. Accordingly, when an advertisement is applied to a game replay video in the 360-degree format, only those advertisements displayed toward an eye gaze of the user in a direction taken by the user are exposed to the user, and all the other advertisements are not exposed to the user.

Whether an advertisement from among those advertisements applied to a 360-degree video is to be exposed to a user is not known until the user actually views that 360-degree video because whether and which advertisement is to be exposed to the user is determined by a direction that the user takes to view by manipulating a display device of the 360-degree video.

However, if an exposure probability of an advertisement applied to a 360-degree video to a user is calculated with reasonable accuracy even before the user views the 360-degree video, it may be possible to set various pricing and standards for applying the advertisement to the 360-degree video or selling an advertisement to be applied to the 360-degree video.

To this end, a system for calculating an exposure probability of an advertisement to be applied to a 360-degree game replay video, to a user, is needed.

### SUMMARY

One or more embodiments include a system for calculating an exposure probability of an advertisement of a 360-degree game replay video, whereby the exposure probability of the advertisement applied to the 360-degree game video, to the user, is calculated in advance.

Additional aspects will be set forth in part in the description which follows and, in part, will be apparent from the description, or may be learned by practice of the presented embodiments.

According to one or more embodiments, a system for calculating an exposure probability of an advertisement of a 360-degree game replay video, includes: a game object storage unit storing, as game object information, shape data corresponding to respective identification numbers of game objects to appear in a game replay video; a game replay information storage unit storing, as game replay information, motion data of the game objects and a virtual camera recording the game objects in a virtual space according to passage of time during a game replay; an advertisement object storage unit storing, as advertisement object information, shape data corresponding to respective identification numbers of advertisement objects to be added to the game replay video; an advertisement applying unit storing advertisement application replay information corresponding to the game replay information stored in the game replay information storage unit and added with motion data of the advertisement objects according to passage of time, stored in the advertisement object storage unit; and an advertisement exposure calculator configured to calculate a probability that each of the advertisement objects is to be exposed in the 360-degree game replay video, to which the advertisement is applied based on the advertisement application replay information by using the game object information, the advertisement object information, and the advertisement application replay information.

### BRIEF DESCRIPTION OF THE DRAWINGS

These and/or other aspects will become apparent and more readily appreciated from the following description of the embodiments, taken in conjunction with the accompanying drawings in which:

FIG. 1 is a block diagram illustrating a system for calculating an exposure probability of an advertisement of a 360-degree game replay video according to an embodiment of the present disclosure; and

FIGS. 2 and 3 are views for describing an operation of calculating an exposure probability of an advertisement object by using the system for calculating an exposure probability of an advertisement of a 360-degree game replay video illustrated in FIG. 1.

### DETAILED DESCRIPTION

Hereinafter, a system for calculating an exposure probability of an advertisement of a 360-degree game replay video according to an embodiment of the present disclosure will be described in detail with reference to the attached drawings.

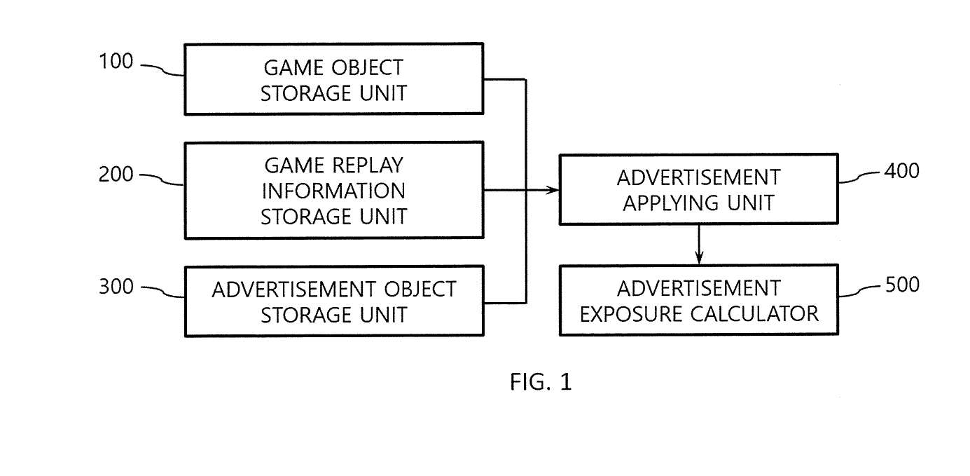

FIG. 1 is a block diagram illustrating a system for calculating an exposure probability of an advertisement of a 360-degree game replay video according to an embodiment of the present disclosure.

Referring to FIG. 1, the system for calculating an exposure probability of an advertisement of a 360-degree game replay video according to the present embodiment includes a game object storage unit 100, a game replay information storage unit 200, an advertisement object storage unit 300, an advertisement applying unit 400, and an advertisement exposure calculator 500.

The present disclosure is directed to a calculation of a probability that an advertisement to be applied to a game video is exposed to a user when the game video is replayed by using a device such as a mobile device, a personal computer (PC), or a head mounted display (HMD), and providing an advertiser or an advertisement seller with information about a result of the calculation.

The present disclosure is used in games developed using a game development tool such as Unity3D or Unreal whereby games are developed by defining a motion of objects such as things, characters, or backgrounds, appearing in a virtual space. The present disclosure is directed to prediction of advertisement exposure possibility by calculating a probability of an advertisement that is applied when replaying a game replay situation recorded by collecting game data and replayed by using a 360-degree display device of a terminal such as a PC or a HMD.

The game object storage unit 100 stores game object information. The game object information refers to shape data corresponding to respective identification numbers of game objects to appear in a game replay video. Characters, items, weapons, props or the like appearing in each game correspond to game objects. Games as described above may be developed to be played on a 360-degree video terminal, or may be games played on a terminal such as a PC or a mobile device. The present disclosure is directed to predicting an exposure probability of advertisement objects 11, 12, 13, 21, 22, and 23 that are applied to a recorded game video of a game developed based on objects and played.

The game replay information storage unit 200 stores game replay information. Game replay information includes motion data of game objects and a virtual camera recording the game objects in the virtual space according to passage of time during a game play. The game replay information as described above is motion of game objects appearing in a game in the virtual space according to passage of time, stored as numerical data, while a user plays the game by using a game terminal. In general, game replay information is collected by recording numerical data such as coordinates and directions of game objects in three-dimensional space in real time by activating a recording function installed on a game terminal while a game player plays a game. By rendering the game replay information in conjunction with the game object information described above, a game play situation of a user may be reproduced.

Unlike a method of generating a video file by collecting image frames according to passage of time and connecting the image frames as in the related art, according to the above-described method, a size of recording data may be remarkably reduced, and a game play situation may be replayed at various image qualities, and a game play situation may be replayed from a different point of view from that of the game player.

According to the system for calculating an advertisement probability exposure of a 360-degree game replay video of the present embodiment, game replay information includes not only information about movements of game objects according to passage of time but also motion data of a virtual camera that records a game play situation, according to passage of time. The motion data of the virtual camera according to passage of time is basically motion defined by a point of view and an eye gaze of a game player, but may also be edited or modified to a different position or in a different direction or path from the point of view of the game player according to necessity.

Due to characteristics of a 360-degree video terminal replaying a 360-degree video, just when a position and a path of a virtual camera are defined, a user may determine a game play situation on a replayed video by operating the 360-degree video terminal in a predetermined direction in 360 degrees from a position of the virtual camera. Thus, while a direction of the virtual camera does not have to be necessarily included in game replay information, according to the system for calculating an exposure probability of an advertisement of the 360-degree game replay video of the present embodiment, the direction of the virtual camera corresponding to an eye gaze direction of a game player is also stored in the game replay information storage unit 200 as game replay information to be used as a basic gaze vector which will be described later. The basic gaze vector may also be edited or modified according to necessity by using various methods.

The advertisement object storage unit 300 stores advertisement object information. The advertisement object information refers to shape data corresponding to respective identification numbers of advertisement objects 11, 12, 13, 21, 22, and 23 to be added to a game replay video. For example, the advertisement objects 11, 12, 13, 21, 22, and 23 may be an advertising board to be displayed in the virtual space, an ad balloon, an image to be displayed on an outer surface of a game object in a texture form. The advertisement objects 11, 12, 13, 21, 22, and 23 may be newly added to the virtual space of the game, or may be printed on an outer surface of existing game objects in the texture form. The advertisement objects 11, 12, 13, 21, 22, and 23 may be a fixed object such as an advertising board or a moving object such as an airship.

The advertisement applying unit 400 stores advertisement application replay information. The advertisement application replay information corresponds to game replay information added with motion data of the advertisement objects 11, 12, 13, 21, 22, and 23 according to passage of time. For example, locations where the advertisement objects 11, 12, 13, 21, 22, and 23 stored in the advertisement object storage unit 300 appear in a game replay video and when and how they appear may be defined by the advertisement application replay information and stored in the advertisement applying unit 400. The advertisement objects 11, 12, 13, 21, 22, and 23 having motion data according to passage of time that is added to the advertisement application replay information are not used as advertisement objects 11, 12, 13, 21, 22, and 23 that are to be included in an actual replay video to be displayed, but are used to calculate a probability that an advertisement is exposed to an eye gaze of the user. Information about the advertisement objects 11, 12, 13, 21, 22, and 23 which are temporarily applied is included in the advertisement application replay information in order to subsequently calculate exposure probabilities corresponding to identification numbers of the advertisement objects 11, 12, 13, 21, 22, and 23 and use the calculated exposure probabilities as data for determining when applying or inserting an advertisement to a replay video.

The motion data of the advertisement objects 11, 12, 13, 21, 22, and 23 according to passage of time, included in the advertisement application replay information as described above, may be automatically generated by using the advertisement applying unit 400, or the advertisement applying unit 400 may receive externally defined data and store the same as the motion data. That is, the advertisement applying unit 400 may insert the advertisement objects 11, 12, 13, 21, 22, and 23 fulfilling predetermined conditions at positions that are set and defined as points where advertisements may be applied in the virtual space of the game from a development stage of a game, or the advertisement applying unit 400 may store data generated by an advertisement seller who intends to apply and sell the advertisement to a game replay video.

The advertisement exposure calculator 500 calculates a probability that each of the advertisement objects 11, 12, 13, 21, 22, and 23 is to be exposed in a 360-degree game replay video to which an advertisement is applied based on advertisement application replay information by using the game object information, the advertisement object information, and the advertisement application replay information.

Various methods may be used as a method of calculating an exposure probability of the advertisement objects 11, 12, 13, 21, 22, and 23 performed by using the advertisement exposure calculator 500.

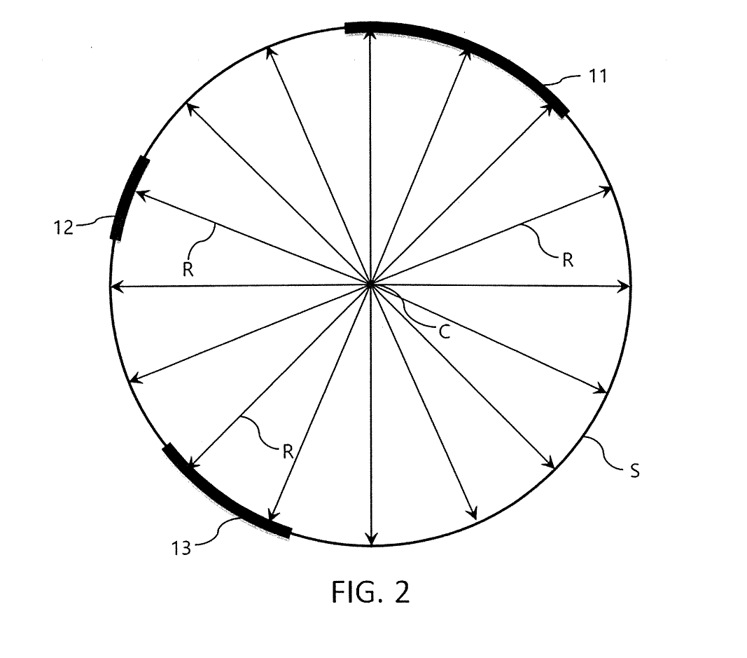

First, as illustrated in FIG. 2, the advertisement exposure calculator 500 generates a plurality of determination gaze vectors R from a center C of a virtual spherical screen S displaying a 360-degree game replay video (a position of the virtual camera). The number and directions of the determination gaze vectors R may be adjusted in various manners. Angles between the determination gaze vectors R may preferably be uniform. By setting a uniform number of the determination gaze vectors R to reach the virtual spherical screen S per unit area as illustrated in FIG. 2, an exposure probability of the advertisement objects 11, 12, and 13 may be calculated effectively. The exposure probability of each of the advertisement objects 11, 12, and 13 may be calculated by determining the number of the determination gaze vectors R that are generated by using the advertisement exposure calculator 500 and have reached each of the advertisement objects 11, 12, and 13. That is, the advertisement object 11, which is reached by three determination gaze vectors R, is calculated to be more likely to be exposed to an eye gaze of a user who views the 360-degree game replay video by using a 360-degree video terminal than the advertisement object 13 which is reached by two determination gaze vectors R.

Since it may be regarded that a probability that a user who uses a 360-degree video terminal will view a 360-degree game replay video toward each point on the virtual spherical screen S is constant at every point of the virtual spherical screen S, an exposure probability of the advertisement objects 11, 12, and 13 may be calculated by using the determination gaze vectors R as described above.

In addition, when using the above-described method, it may be also taken into consideration when the advertisement objects 11, 12, and 13 are hidden due to another object located between the position C of the virtual camera and the advertisement objects 11, 12, and 13. When another object corresponding to an obstacle is present, the determination gaze vector R does not reach the advertisement objects 11, 12, and 13, and thus, this case may be estimated as a case where the advertisement objects 11, 12, and 13 are not exposed, thereby even more accurately calculating exposure probabilities of the advertisement objects 11, 12, and 13.

Here, by calculating exposure probabilities of the advertisement objects 11, 12, and 13 by considering areas (sizes) of the advertisement objects 11, 12, and 13 displayed on the virtual spherical screen S, exposure probabilities of the advertisement objects 11, 12, and 13 may be calculated effectively.

Meanwhile, the advertisement exposure calculator 500 may calculate exposure probabilities of the advertisement objects 11, 12, and 13 by determining only those advertisement objects 11, 12, and 13 that are displayed on the virtual spherical screen S and have an area within a preset range of area, as being exposed. If the area of the advertisement objects 11, 12, and 13 displayed on the virtual spherical screen S is too small, even when they are displayed within a field of view of a user, the user may not recognize them as an advertisement; when the advertisement objects 11, 12, and 13 are displayed beyond a range of the field of view of the user, the user may also not recognize them as the advertisement either. Considering these cases, an upper limit and a lower limit of the areas of the advertisement objects 11, 12, and 13 may be set, and the advertisement objects 11, 12, and 13 that are outside the upper and lower limits may be calculated as not being exposed, thereby accurately calculating exposure probabilities of the advertisement objects 11, 12, and 13.

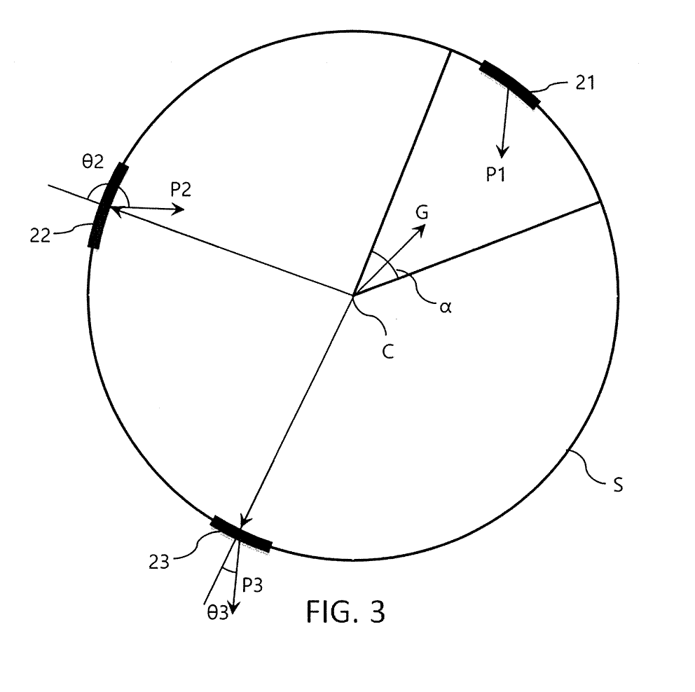

Referring to FIG. 3, the advertisement exposure calculator 500 may calculate exposure probabilities of the advertisement objects 21, 22 and 23 by considering a direction of the advertisement objects 21, 22 and 23 displayed on the virtual spherical screen S. Even when the advertisement objects 21, 22 and 23 are within a range of a field of view of a 360-degree video terminal, the advertisement exposure calculator 500 may determine those advertisement objects 21, 22 and 23 that are facing a different direction from an eye gaze of a user, as being not exposed.

To this end, a gaze vector G is defined. A vector extending from a center C of a virtual spherical screen S toward each of the advertisement objects 21, 22 and 23 is defined as the gaze vector G. A direction in which the advertisement object 21, 22 or 23 displayed in the virtual space is displayed is respectively defined as an advertisement vector P1, P2, or P3. The advertisement vectors P1, P2, and P3 are directions in which the advertisement objects 21, 22, and 23 are displayed to be viewed best. The advertisement vector of an advertising board or a banner is a direction perpendicular to a plane on which an advertisement of the advertising board or the banner is displayed. The advertisement objects 21, 22, and 23 having a spherical shape or a curved surface, such as an ad balloon, may have a plurality of advertisement vectors P1, P2, and P3.

Angles between the gaze vector G and the advertisement vectors P1, P2, and P3 are defined to be advertisement orientation angles θ2 and θ3. When the advertisement orientation angles θ2 and θ3 are within a set range, the advertisement exposure calculator 500 determines that the advertisement objects corresponding to the advertisement vectors P2, and P3 are visually exposed to a user. When the advertisement orientation angles θ2 and θ3 are outside the set range, the advertisement exposure calculator 500 determines that the advertisement objects corresponding to the advertisement vectors P2, and P3 are not visually exposed to the user. For example, when the advertisement orientation angles θ2 and θ3 are within a range of about 120 degrees to about 180 degrees, the advertisement exposure calculator 500 determines that the advertisement objects 22, and 23 are exposed to the user.

To this end, the advertisement exposure calculator 500 receives, in advance, an exposure reference angle that may be used as a reference for determining that the advertisement objects 21, 22, and 23 are exposed to a 360-degree display device, and stores the exposure reference angle.

When an advertisement orientation angle θ2 is an obtuse angle, the advertisement object 22 is exposed to an inner portion of the virtual spherical screen S. When an advertisement orientation angle θ3 is an acute angle, the advertisement object 23 is exposed to an outer portion of the virtual spherical screen S. For example, when the advertisement orientation angles θ2 and θ3 are within a range of about 120 degrees to about 180 degrees, it may be determined that an advertisement object is relatively distinctly exposed to an eye gaze of the user.

As described above, the advertisement exposure calculator 500 calculates an exposure probability of each of the advertisement objects 21, 22, and 23 based on the preset advertisement orientation angles θ2 and θ3.

In general, portions of a 360-degree video that are viewed by a user by using a terminal are constant with respect to all directions of the virtual spherical screen S. However, for a game replay video, sometimes, it may be highly likely that the user views the game play video by adjusting an eye gaze direction with respect to a predefined direction. For example, the user may view a game replay video by adjusting an eye gaze direction when key sound effects are inserted, as a point of interest (POI), in a direction or into a predetermined space where an important event of a game occurs.

As described above, a direction that is likely to be faced by a user viewing a 360-degree game replay video may be set as a basic gaze vector, and the advertisement exposure calculator 500 may calculate exposure probabilities of the advertisement objects 21, 22, and 23 by considering the basic gaze vector. In this case, a direction of the basic gaze vector according to passage of time is included in game replay information and stored in advance by the game replay information storage unit 200.

The advertisement exposure calculator 500 calculates exposure probabilities of the advertisement objects 21, 22, and 23 by respectively applying weights to the advertisement objects 21, 22, and 23 located within an angle of view (a) of the 360-degree display device with respect to the basic gaze vector (by considering a relatively high exposure probability of the advertisement object). The basic gaze vector described above is frequently set as a direction displayed by a terminal of an actual game player in a game play situation that is being recorded (direction of a virtual camera), and may be edited in light of the point of interest (POI) described above.

A direction of the basic gaze vector described above may also be set by using a method as follows. A path taken by a virtual camera according to passage of time is stored in the game replay information storage unit 200, and thus, the advertisement exposure calculator 500 may set a tangential direction of the path of the virtual camera in the virtual game space as a basic gaze vector, and may apply a weight to the advertisement objects 21, 22, and 23 located within the angle of view (a) of the 360-degree display device with respect to the basic gaze vector to thereby calculate exposure probabilities of the advertisement objects 21, 22, and 23.

As described above, when the weights are applied to the advertisement objects 21, 22, and 23 located within a range of the angle of view (a) around the basic gaze vector by using the basic gaze vector, a likelihood of exposure of advertisement may be calculated by thoroughly reflecting the characteristics of a game video being replayed. A viewer who watches a 360-degree game replay video is likely to view the 360-degree game replay video by orienting towards the same line as an eye gaze of an actual game player or adjusting one's own eye gaze in a direction in which the virtual camera moves, and thus, the advertisement exposure calculator 500 may effectively calculate the exposure probability of the advertisement objects 21, 22, and 23 by reflecting a result of predicting the user's behavior.

Exposure probabilities of the advertisement objects 11, 12, 13, 21, 22, and 23 calculated by the advertisement exposure calculator 500 by using the above-described methods in combination may be used in various manners. As the advertisement exposure calculator 500 generates advertisement exposure probabilities of the advertisement objects 11, 12, 13, 21, 22, and 23 according to passage of time as an output, the advertisement seller may sell advertisements by putting different prices on the advertisement objects 11, 12, 13, 21, 22, and 23 based on the result calculated as described above. That is, the calculation result described above may be used by the advertisement seller as a basis for setting a reasonable price of the advertisement when selling the advertisement. In addition, an advertiser may use the result obtained by using the advertisement exposure calculator 500 as a basis for determining to expose the advertisement of the advertiser to which of the advertisement objects 11, 12, 13, 21, 22, 23 of the 360-degree game replay video or at which point in time. By using the result of the advertisement exposure calculator 500, the advertisement seller may sell advertisements to be applied to each of the advertisement objects 11, 12, 13, 21, 22, and 23 or to replay time zones of the 360-degree game replay video in an auction manner.

The method of calculating an exposure probability of an advertisement of a 360-degree game replay video by using the system for calculating the exposure probability of the advertisement of the 360-degree game replay video according to the present disclosure as described above is used to obtain data to be used when determining the exposure probability of the advertisement, a frequency of the exposure, and a meaningful exposure of the advertisement in the 360-degree game replay video, and thus, the advertisement object information stored in the advertisement object storage unit 300 described above does not have to be specific and meaningful advertisement, which is actually used, but may be information about the advertisement objects 11, 12, 13, 21, 22, and 23 for test purposes.

The user selects or specifies concrete and actual advertisement objects 11, 12, 13, 21, 22, and 23 based on the result obtained by using the system for calculating an exposure probability of an advertisement of a 360-degree game replay video according to the present disclosure, or stores sold advertising objects 11, 12, 13, 21, 22, and 23 in the advertisement object storage unit 300. A new 360-degree game replay video is generated by using the same method in which the advertisement application unit 400 operates by using a stored advertisement objects 11, 12, 13, 21, 22, and 23 as described above. A generated advertisement video is uploaded to a game video-providing server or the like for general users to watch or is provided through various online services.

While the present disclosure has been described with reference to preferred embodiments, the scope of the present disclosure is not limited to the above described and illustrated structures.

For example, while some of the methods for calculating an exposure probability of the advertisement objects 11, 12, 13, 21, 22, and 23 and a method of applying weights to the advertisement objects 11, 12, 13, 21, 22, and 23 have been described above in detail, a system for calculating the exposure probability of an advertisement of a 360-degree game replay video may be configured by selectively combining the above-described methods or also by using just one of the methods.

In addition, while an example of the system for calculating an exposure probability of an advertisement of a 360-degree game replay video, whereby the exposure probability of the advertisement objects 11, 12, 13, 21, 22, 23 is calculated by using a basic gaze vector, has been described above, according to circumstances, the system for calculating the exposure probability of the advertisement of the 360-degree game replay video, in which an advertisement exposure calculator 500 calculates the exposure probabilities of advertisement objects 11, 12, 13, 21, 22, and 23 based on only a path of a virtual camera without using the concept of the basic gaze vector may also be configured.

The system for calculating an exposure probability of an advertisement of a 360-degree game replay video according to the present disclosure allows to conduct reasonable calculation of a probability that the advertisement is exposed to a user when the user is watching the 360-degree game replay video to which the advertisement is applied, thereby providing information to be effectively used for placement or sale of advertisements, estimation of advertising costs or the like.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope of the inventive concept as defined by the following claims.

1. A system for calculating an exposure probability of an advertisement of a 360-degree game replay video, the system comprising:
a game object storage unit, storing, as game object information, shape data corresponding to respective identification numbers of game objects to appear in a 360-degree game replay video;
a game replay information storage unit, storing, as game replay information, motion data of the game objects and a virtual camera recording the game objects in a virtual space according to passage of time during a game replay;
an advertisement object storage unit, storing, as advertisement object information, shape data corresponding to respective identification numbers of advertisement objects to be added to the 360-degree game replay video;
an advertisement applying unit, storing advertisement application replay information corresponding to the game replay information stored in the game replay information storage unit and added with motion data of the advertisement objects according to passage of time, stored in the advertisement object storage unit; and
an advertisement exposure calculator, configured to calculate the exposure probability that each of the advertisement objects is to be exposed in the 360-degree game replay video, to which the advertisement is applied based on the advertisement application replay information by using the game object information, the advertisement object information, and the advertisement application replay information.

2. The system of claim 1, wherein the advertisement exposure calculator generates a plurality of determination gaze vectors from a center of a virtual spherical screen displaying the 360-degree game replay video (a position of the virtual camera) to calculate the exposure probability of each of the advertisement objects based on the number of determination gaze vectors that have reached each of the advertisement objects.

3. The system of claim 2, wherein the advertisement exposure calculator generates the plurality of determination gaze vectors such that a uniform number of the plurality of determination gaze vectors reaches the virtual spherical screen per unit area.

4. The system of claim 2, wherein the advertisement exposure calculator determines advertisement objects as being exposed only when an angle (advertisement orientation angle) between the determination gaze vector extending from the center of the virtual spherical screen toward each of the advertisement objects and a direction of the advertisement objects is within a preset range of angle so as to calculate the exposure probability of the advertisement objects.

5. The system of claim 2, wherein the advertisement exposure calculator determines advertisement objects as being exposed only when an area of the advertisement objects displayed on the virtual spherical screen is within a preset range of area so as to calculate the exposure probability of the advertisement objects.

6. The system of claim 2, wherein the game replay information stored in the game replay information storage unit further comprises a basic gaze vector corresponding to an eye gaze direction of a game player (a direction of the virtual camera) according to passage of time during a game play,
wherein the advertisement exposure calculator calculates the exposure probability of the advertisement objects by applying a weight to the advertisement objects located within a range of a field of angle of a 360-degree display device with respect to the basic gaze vector.

7. The system of claim 2, wherein the advertisement exposure calculator calculates the exposure probability of the advertisement objects by setting a tangential direction of a path of the virtual camera stored in the game replay information storage unit as a basic gaze vector and applying a weight to the advertisement objects located within a range of a field of angle of a 360-degree display device with respect to the basic gaze vector.

8. The system of claim 3, wherein the advertisement exposure calculator determines advertisement objects as being exposed only when an angle (advertisement orientation angle) between the determination gaze vector extending from the center of the virtual spherical screen toward each of the advertisement objects and a direction of the advertisement objects is within a preset range of angle so as to calculate the exposure probability of the advertisement objects.

9. The system of claim 3, wherein the advertisement exposure calculator determines advertisement objects as being exposed only when an area of the advertisement objects displayed on the virtual spherical screen is within a preset range of area so as to calculate the exposure probability of the advertisement objects.

10. The system of claim 3, wherein the game replay information stored in the game replay information storage unit further comprises a basic gaze vector corresponding to an eye gaze direction of a game player (a direction of the virtual camera) according to passage of time during a game play,
wherein the advertisement exposure calculator calculates the exposure probability of the advertisement objects by applying a weight to the advertisement objects located in a range of a field of angle of a 360-degree display device with respect to the basic gaze vector.

11. The system of claim 3, wherein the advertisement exposure calculator calculates the exposure probability of the advertisement objects by setting a tangential direction of a path of the virtual camera stored in the game replay information storage unit as a basic gaze vector and applying a weight to the advertisement objects located within a range of a field of angle of a 360-degree display device with respect to the basic gaze vector.
